(19) United States
(12) Patent Application Publication
(10) Pub. No.: US 2026/0134615 A1
(43) Pub. Date: May 14, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Keigo YONEDA, Kanagawa (JP)

(21) Appl. No.: 19/369,479

(22) Filed: Oct. 27, 2025

(30) Foreign Application Priority Data
Nov. 11, 2024 (JP) 2024-196608

(51) Int. Cl. G06T 15/20; G06F 3/04815; G06F 3/14

(52) U.S. Cl. CPC G06T 15/205; G06F 3/04815; G06F 3/1454

(57) ABSTRACT

An object is to enable a plurality of user to smoothly communicate with each other while sharing a virtual viewpoint image. An image processing apparatus which generates·outputs a virtual viewpoint image according to the present disclosure generates, based on an operation of a first user, a virtual viewpoint image based on a plurality of images captured by a plurality of image capturing apparatuses, the virtual viewpoint image reflecting an instruction from the first user to a second user. Then, the generated virtual viewpoint image is outputted to a user terminal used by the second user, based on the operation of the first user.

### BACKGROUND

### Field of the Technology

The present disclosure relates to an image processing apparatus relating to a virtual viewpoint image, a control method, and a storage medium.

### Description of the Related Art

In recent years, there has been a technology in which a plurality of cameras are installed at different positions to capture images from multiple view points in synchronization, and not only images from the camera installation positions but also a virtual viewpoint image from desired one or more viewpoints are generated by using a plurality of images obtained by the image capturing. In a service using a virtual viewpoint image, for example, a powerful virtual viewpoint content as if a view from the eyes of a player, for example, can be produced by a video producer from a plurality of images obtained by capturing images of a game of basketball with a plurality of cameras in synchronization. In addition, the users who are viewing virtual viewpoint contents can freely move virtual viewpoints by themselves, and the users can also watch the game while viewing virtual viewpoint images corresponding to various viewpoints.

It has also been proposed to use such virtual viewpoint images for coaching in sports, for example. In the case of application to coaching in sports, it is assumed that a player who receives coaching (a person who is given an instruction) receives an instruction of a coach (a person who gives an instruction) while viewing a virtual viewpoint image with an HMD, for example. In such a situation, it is necessary that the player can correctly grasp the content of the instruction from the coach. Regarding this point, Japanese Patent Laid-Open No. 2007-042073 discloses an image presentation system which allows a content of an instruction from another user who is viewing a virtual space image with a non-HMD to a user who is viewing the virtual space image with an HMD to be reflected in the virtual space image of the HMD.

### SUMMARY

An image processing apparatus according to the present disclosure has: one or more memories storing instructions; and one or more processors executing the instructions to: receive an operation of a first user; generate, based on the received operation of the first user, a virtual viewpoint image based on a plurality of images captured by a plurality of image capturing apparatuses, the virtual viewpoint image reflecting an instruction from the first user to a second user; and output the generated virtual viewpoint image to a user terminal used by the second user, based on the operation of the first user.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are diagrams showing an example of a configuration of an image processing system;

FIGS. 2A and 2B are examples of hardware configurations of a user terminal and an image processing apparatus;

FIG. 3 is a diagram showing an example of a software configuration (a functional configuration) of the image processing apparatus;

FIGS. 4A and 4B are diagrams showing examples of GUIs of a first user terminal;

FIG. 5 is a diagram showing an example of a second virtual viewpoint image displayed on an HMD;

FIG. 6 is a flowchart showing generation·output processing of a virtual viewpoint image, which is conducted by the image processing apparatus;

FIG. 7 is a flowchart showing a detail of image output processing in the case where a screen sharing operation is not being received;

FIG. 8 is a flowchart showing a detail of image output processing in the case where a screen sharing operation is being received; and

FIG. 9 is a diagram showing an example of a GUI of the first user terminal.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

In the technique of Japanese Patent Laid-Open No. 2007-042073 described above, the display position of the content of an instruction is determined based on a virtual space image which a non-HMD wearer who is a person who gives an instruction views, and the content of the instruction is displayed on a virtual space image which an HMD wearer who is a person who is given an instruction views. Here, for example, a case where a virtual space is of a wide range, and a person who is given an instruction and a person who gives an instruction are at different places in the virtual space, and a case where a person who is given an instruction and a person who gives an instruction are paying attention to different things in a virtual space because the position of an object of an instruction target changes over time, or because of another reason are considered. In such cases, the consideration of the present inventor revealed that according to the technology of Japanese Patent Laid-Open No. 2007-042073, there is a possibility that the content of an instruction from a person who gives an instruction is not correctly transmitted to a person who is given an instruction.

### First Embodiment

In the present embodiment, an image processing system which generates a virtual viewpoint image representing an appearance from a designated virtual viewpoint based on a plurality of images which are based on images captured by a plurality of image capturing apparatuses and the designated virtual viewpoint will be described. The "virtual viewpoint image" in the present embodiment is not limited to an image corresponding to a virtual viewpoint freely designated by a user (as desired), but the virtual viewpoint image also includes, for example, an image corresponding to a virtual viewpoint selected by a user from among a plurality of virtual viewpoint candidates, and the like. In addition, in the present embodiment, a case where the designation of a virtual viewpoint is conducted by an input of a user operation is mainly described; however, the designation of a virtual viewpoint may be automatically conducted based on a result of an image analysis or the like. Note that in the present embodiment, a case where a virtual viewpoint image is a moving image will be mainly described; however, the virtual viewpoint image may be a still image.

In addition, the present embodiment will be described by using a term "virtual camera". The virtual camera is a virtual image capturing apparatus which is different from a plurality of image capturing apparatuses actually installed around an image capturing region, and is a concept for describing a virtual viewpoint relating to the generation of a virtual viewpoint image for convenience. That is, the virtual viewpoint image can be deemed as an image captured from a virtual viewpoint set in a virtual space which is associated with an image capturing region. Then, the position and the direction of a virtual viewpoint in the captured image can be expressed as the position and the direction (orientation) of a virtual camera. In other words, in the case where a camera is assumed to be present at a position of a virtual viewpoint set in a virtual space corresponding to an actual space where actual image capturing is conducted, the virtual viewpoint image can be said to be an image simulating a captured image obtained by this camera.

### System Configuration

In the present embodiment, a use case in which a coach of basketball (a person who gives an instruction) instructs a player (a person who is given an instruction) by using a virtual viewpoint image will be described as an example. In this use case, a mode is assumed in which the coach gives an instruction by using a desktop PC as a first user terminal, and the player receives the instruction from the coach by wearing an HMD as a second user terminal. Here, in the case where the coach attempts to instruct the player by using a virtual viewpoint image displayed on a display of the desktop PC, the player has to take off the HMD for every instruction, and is thus prevented from concentrating on viewing a virtual viewpoint image displayed on the HMD. In view of this, for example, it is considered that a 3D model (hereinafter, referred to as an "instruction model") using a CG which expresses an instruction from the coach to the player is displayed in a virtual space to generate a virtual viewpoint image. However, in the case where the line of sight of the player is not directed toward where the instruction model is disposed, and the instruction model exists outside the angle of view of the virtual viewpoint image which the player is viewing, the player cannot recognize the instruction of the coach after all. In addition, even in the case where an instruction model is attempted to be disposed while the virtual viewpoint image which the player is viewing is displayed on the display of the desktop PC, it is difficult to dispose the instruction model at an appropriate position while looking at a video which swings in association with the movement of the head of the player. Moreover, it is necessary to continuously display the instruction model in the virtual viewpoint image in association with the line of sight of the player, which can change from hour to hour. In view of this, in the present embodiment, an image processing system that is particularly suitable for such coaching will be described.

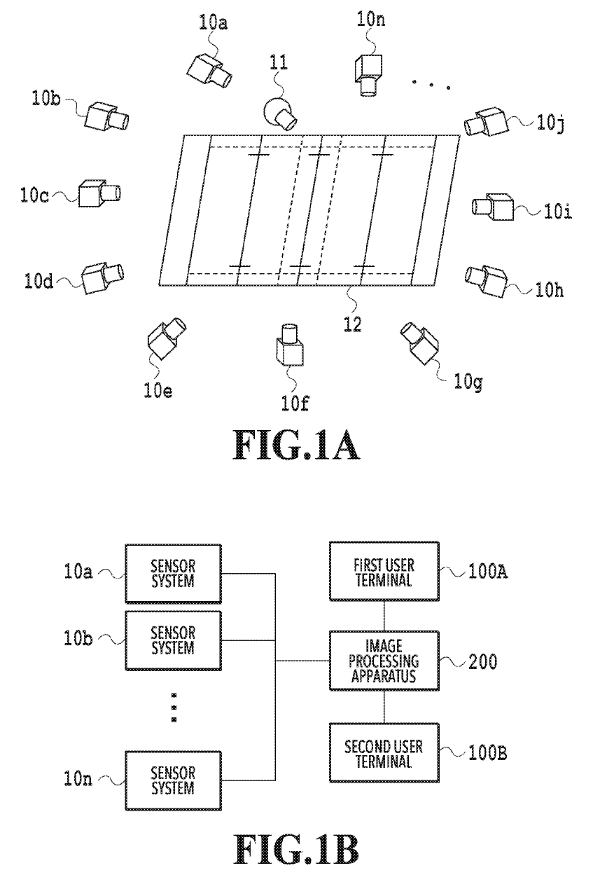

First, with reference to FIGS. 1A and 1B, a configuration of the image processing system according to the present embodiment will be described. The image processing system of the present embodiment includes n sensor systems 10a to 10n, and each sensor system includes at least one camera, which is an image capturing apparatus. In the following, the n sensor systems are not distinguished from one another, and will be described as a "plurality of sensor systems 10" unless otherwise particularly specified.

FIG. 1A is a diagram showing an example of installation of the plurality of sensor systems 10 which surround an image-capturing target region 12, and a virtual camera 11 which does not exist in reality, in a real three-dimensional space. The plurality of sensor systems 10 capture images of the region 12 from different directions, respectively. In the example of the present embodiment, the description will be made on the assumption that the image-capturing target region 12 is a court where a basketball game is held, and n (for example, 100) sensor systems 10 are installed in such a manner as to surround the court. The image-capturing target region 12 may include spectator's seats beside the basketball court. In addition, the image-capturing target region 12 is not limited to an indoor region, but may be an outdoor stadium, stage, or the like. In addition, the plurality of sensor systems 10 do not have to be installed over the entire periphery of the region 12, and may be installed only in part of the periphery of the region 12 depending on limitation in installation locations, or the like. In addition, the plurality of cameras included in the plurality of sensor systems 10 may include an image capturing apparatus having a different function, such as a telephoto camera or an ultrawide-angle camera. The plurality of cameras included in the plurality of sensor systems 10 capture images in synchronization. A plurality of images obtained by image-capturing by these plurality of cameras are referred to as "multi-view images". Note that each of the multi-view images in the present embodiment may be a captured image, or an image (a foreground image) obtained by conducting image processing such as foreground extraction processing, for example, on a captured image.

The virtual camera 11 is set in a virtual space associated with the region 12, and can be set at a position of a viewpoint different from any of the cameras of the plurality of sensor systems 10. A virtual viewpoint image generated by an image processing apparatus 200 is an image representing an appearance from the virtual camera 11. Here, for a virtual viewpoint image to be provided to a first user terminal 100A and a virtual viewpoint image to be provided to a second user terminal 100B, different virtual cameras can be set, respectively. Note that the plurality of sensor systems 10 may include microphones (not shown) in addition to the cameras. The respective microphones of the plurality of sensor systems 10 pick up sounds in synchronization. Based on the sounds thus picked up, an acoustic signal which is to be played along with the display of a virtual viewpoint image in a user terminal, described later, can be generated. Although the description of sounds will be omitted below for simplifying the description, images and sounds are basically processed together.

FIG. 1B is a diagram showing a configuration of the entire image processing system according to the present embodiment. The image processing system includes the first user terminal 100A, the second user terminal 100B, and the image processing apparatus 200 in addition to the above-mentioned plurality of sensor systems 10.

The first user terminal 100A is an information processing apparatus such as a desktop PC or a tablet terminal, for example, which is used by a first user (the coach who coaches the player in the present embodiment) to designate a virtual viewpoint or to view a virtual viewpoint image. The first user terminal 100A receives an operation signal of a virtual camera via a mouse or the like by the first user, and transmits the operation signal to the image processing apparatus 200. In addition, the first user terminal 100A displays a virtual viewpoint image received from the image processing apparatus 200 on an external or built-in display apparatus (not shown) such as a liquid-crystal display.

The image processing apparatus 200 is an information processing apparatus as an image processing server which generates a virtual viewpoint image and provides the virtual viewpoint image to the first user terminal 100A/the second user terminal 100B. The image processing apparatus 200 obtains multi-view images from the plurality of sensor systems 10, and stores the multi-view images together with time codes at the time of image capturing in a database (not shown). The time code is information for uniquely identifying the time at which an image capturing apparatus captured an image, and held in such a format as, for example, "Day: Time: Minute: Second: Frame Number". Then, the image processing apparatus 200 generates a virtual viewpoint image corresponding to a designated virtual viewpoint by using multi-view images stored in the database, and provides the virtual viewpoint image to the first user terminal 100A and the second user terminal 100B. A virtual viewpoint image is generated by, for example, model-based rendering (MBR). The MBR is a method for generating a virtual viewpoint image by using three-dimensional shape data (a 3D model) of an object, which is generated based on a plurality of images obtained by capturing images of the object from a plurality of directions. A 3D model can be obtained by a three-dimensional shape reconstruction method such as a visual hull method, for example.

The second user terminal 100B is an information processing apparatus such as an HMD or a tablet terminal, for example, for a second user (the player in the present embodiment) to view a virtual viewpoint image generated by the image processing apparatus 200. Note that it is also possible to designate a virtual viewpoint based on an operation input in the second user terminal 100B by the second user. For example, in the case where the second user terminal 100B is an HMD, an operation signal of a so-called first-person viewpoint is generated by the second user who is wearing the HMD moving the 's own head, and the operation signal is sent to the image processing apparatus 200 as information designating a virtual viewpoint.

### Hardware Configurations of User Terminal and Image Processing Apparatus

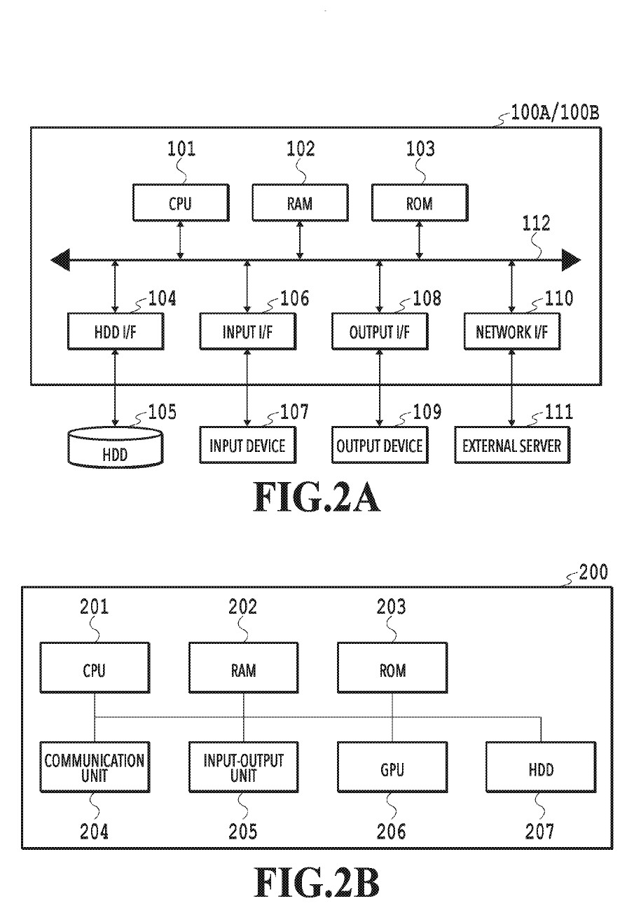

Next, examples of hardware configurations of the user terminal and the image processing apparatus in the present embodiment will be described with reference to FIGS. 2A and 2B.

FIG. 2A is an example of a hardware configuration of the user terminal, which is an information processing apparatus. Although the first user terminal 100A will be described here, the second user terminal 100B also has a similar configuration to this.

A CPU 101 executes programs stored in a ROM 103 and/or a hard disk drive (HDD) 105 by using a RAM 102 as a work memory, and controls each configuration, which will be described later, via a system bus 112. In this way, various processings, which will be described later, are executed.

An HDD interface (I/F) 104 is an interface such as serial ATA (SATA), for example, which connects the user terminal 100A and the HDD 105. The CPU 101 is capable of reading out data from the HDD 105, and writing data into the HDD 105, via the HDD interface (I/F) 104. Moreover, the CPU 101 deploys data stored in the HDD 105 onto the RAM 102. In addition, the CPU 101 is capable of storing various data on the RAM 102, which is obtained by executing programs, into the HDD 105. Note that the HDD is an example of a secondary storage apparatus, and an optical disk drive, an SSD, a flash memory, or the like may be used.

An input interface (I/F) 106 connects an input device 107, such as a touch panel, a keyboard, a mouse, a digital camera, or a scanner for inputting one or a plurality of coordinates, and the user terminal 100A. The input interface (I/F) 106 is a serial bus interface such as USB or IEEE1394, for example. The CPU 101 is capable of reading data from the input device 107 via the input I/F 106.

An output interface (I/F) 108 connects an output device 109 such as a display and the user terminal 100A. The output interface (I/F) 108 is a video output interface such as DVI or HDMI (registered trademark), for example. The CPU 101 causes the output device 109 to display a virtual viewpoint image by sending data on the virtual viewpoint image to the output device 109 via the output I/F 108. A network interface (I/F) 110 is a network card such as a LAN card, for example, which connects the user terminal 100A and an external server 111. The CPU 101 is capable of reading out data from the external server 111 via the network I/F 110.

FIG. 2B is an example of a hardware configuration of the image processing apparatus 200. A CPU 201 executes programs stored in a ROM 203 by using a RAM 202 as a work memory, and controls each configuration, which will be described later.

A communication unit 204 connects to external apparatuses such as the first user terminal 100A and the second user terminal 100B, and conducts data communications. The communication unit 204 conducts communications in accordance with a communication standard such as Ethernet or IEEE802.11 (a so-called wireless LAN), for example. The CPU 201 transmits and receives data to and from an external apparatus via the communication unit 204.

An input-output unit 205 conducts input and output of data via an input interface and an output interface, which are not shown. Devices such as a mouse, a keyboard, a display, and a digital camera are connected to the input-output unit 205.

A GPU 206 is a calculation apparatus specialized for image processing. The GPU 206 conducts rendering processing and the like for generating a virtual viewpoint image from multi-view images inputted from the plurality of sensor systems 10.

An HDD 207 is a secondary storage apparatus for storing image data and the like. Note that an optical disk drive, an SSD, a flash memory, or the like may be used instead of an HDD.

### Software Configuration of Image Processing Apparatus

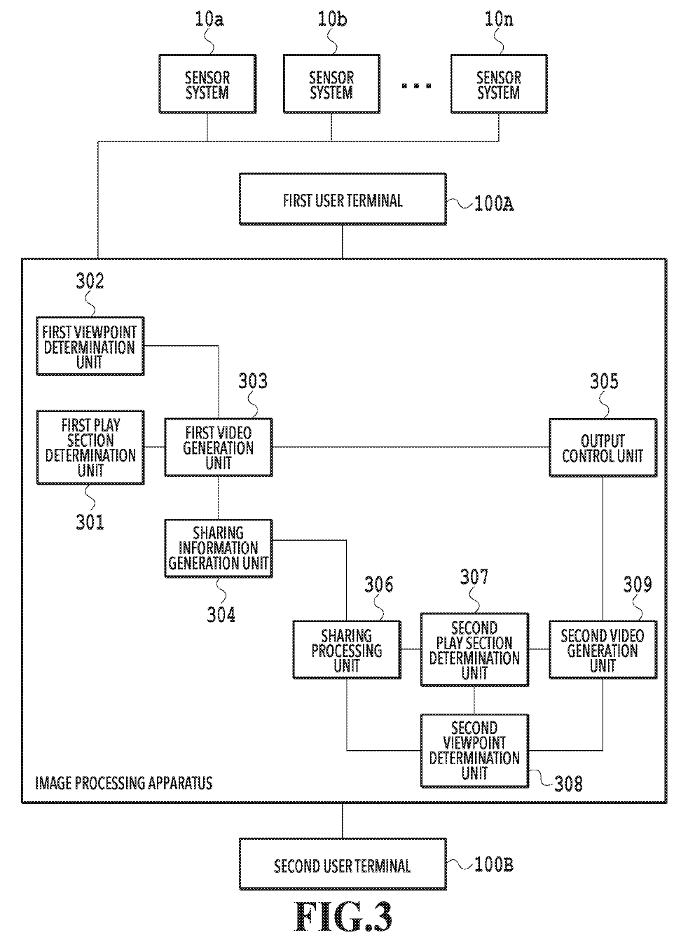

Next, a functional configuration of the image processing apparatus 200 according to the present embodiment will be described with reference to FIG. 3. The image processing apparatus 200 is configured with a first play section determination unit 301, a first viewpoint determination unit 302, a first video generation unit 303, a sharing information generation unit 304, an output control unit 305, a sharing processing unit 306, a second play section determination unit 307, a second viewpoint determination unit 308, and a second video generation unit 309.

The first play section determination unit 301 determines a play section of a virtual viewpoint image to be generated by the first video generation unit 303 in accordance with an operation signal of the first user which is inputted from the first user terminal 100A. Here, the "play section" means a time range of the virtual viewpoint image among the entire time range of inputted multi-view images, and is defined by using a starting time code indicating a starting time and an ending time code indicating an ending time, for example.

The first viewpoint determination unit 302 determines external parameters representing a virtual viewpoint for the first video generation unit 303 to generate a virtual viewpoint image, that is, the position and orientation of the virtual camera, in accordance with an operation signal of the first user which is inputted from the first user terminal 100A. Here, the position of the virtual camera is represented by three-dimensional coordinates (x, y, z) composed of thee axes of an x axis, a y axis, and a z axis, for example. In addition, the orientation of the virtual camera is specified by values (pan, tilt, roll) of three axes of a pan axis, a tilt axis, and a roll axis, for example. The pan axis represents the movement of the camera in the left-right direction, the tilt axis represents the movement of the camera in the up-down direction, and the roll axis represents the rotation of the camera about the optical axis. Note that it is assumed that internal parameters such as the focal length and the angle of view (an image capturing region) of the virtual camera has been determined in advance.

The first video generation unit 303 generates a virtual viewpoint image based on the inputted multi-view images, the play section determined by the first play section determination unit 301, and the position and orientation of the virtual camera determined by the first viewpoint determination unit 302.

The sharing information generation unit 304 generates image generation information (hereinafter, referred to as "sharing information") for sharing a virtual viewpoint image between the first user and the second user, and giving an instruction from the first user to the second user. This sharing information contains information indicating the content of an instruction from the first user to the second user, information indicating the display position of the instruction, information on a virtual viewpoint such as the position·orientation of the virtual camera and the play section for generating a virtual viewpoint image. Here, the "information indicating the content of an instruction" contains, for example, a CG of a character string expressing an advice which the coach wants to convey to the player, a CG representing a figure such as an arrow indicating a portion to which attention is desired to be paid in an image, and also a change in color of a specific region in an image, for example, and the like. In addition, the "display position (of the instruction)" is a position at which the content of an instruction is displayed in a virtual space, and represented by, for example, three-dimensional coordinates (x, y, z). Note that the sharing information may contain another element (for example, the play speed of the virtual viewpoint image), and does not have to contain all the above-mentioned elements. The sharing information thus generated is stored in the RAM 202 of the image processing apparatus 200.

The sharing processing unit 306 obtains all pieces of sharing information generated by the sharing information generation unit 304 and stored in the RAM 202, and selects one piece of sharing information which the first user desires. The sharing information thus selected is sent to the second play section determination unit 307 and the second viewpoint determination unit 308.

The second play section determination unit 307 determines a play section of a virtual viewpoint image to be generated by the second video generation unit 303. In this case, the play section is determined based on the sharing information while a screen sharing operation by the first user is being received (while the sharing information has been selected by the sharing processing unit 306), or in accordance with an operation input of the first user which is inputted from the first user terminal 100A while the screen sharing operation by the first user is not being received. Note that the play section may be determined in accordance with an operation input of the second user which is inputted from the second user terminal 100B, while the screen sharing operation by the first user is not being received. This makes it possible for the player to view a desired virtual viewpoint image in a free play section while the coach is not making a screen sharing instruction.

The second viewpoint determination unit 308 determines external parameters representing a virtual viewpoint for the second video generation unit 303 to generate a virtual viewpoint image, that is, the position and orientation of the virtual camera. In this case, while a screen sharing operation by the first user is being received, those other than the height (x) of the virtual viewpoint among the position (x, y, z) and the orientation (pan, tilt, roll) of the virtual viewpoint are determined to be values of the position and the orientation contained in the sharing information. Then, the height (x) of the virtual viewpoint is determined in accordance with an operation signal of the second user which is inputted from the second user terminal 100B. In this way, a virtual viewpoint image which matches the height of the eye line of the second user (the player) while following the virtual viewpoint determined by the first user (the coach) in general other than the height is generated. On the other hand, while a screen sharing operation by the first user is not being received, external parameters are determined in accordance with an operation input of the second user which is inputted from the second user terminal 100B (in the case of an HMD, an operation signal representing the movement of the head of the second user which is detected by an acceleration sensor or a gyroscope sensor mounted inside the HMD). Note that like the first viewpoint determination unit 302, it is assumed that internal parameters such as the focal length and the angle of view (an image capturing region) of the virtual camera has been determined in advance.

The second video generation unit 309 generates a virtual viewpoint image based on the inputted multi-view images, the play section determined by the second play section determination unit 307, and the position and orientation of the virtual camera determined by the second viewpoint determination unit 308.

The output control unit 305 controls output of virtual viewpoint images generated by the first video generation unit 303 and the second video generation unit 309. Specifically, the output control unit 305 transmits a virtual viewpoint image generated by the first video generation unit 303 (hereinafter, referred to as a "first virtual viewpoint image") to the first user terminal 100A, and a virtual viewpoint image generated by the second video generation unit 309 (hereinafter, referred to as a "second virtual viewpoint image") to the first user terminal 100A and the second user terminal 100B, via the communication unit 204.

### Explanation of GUIs

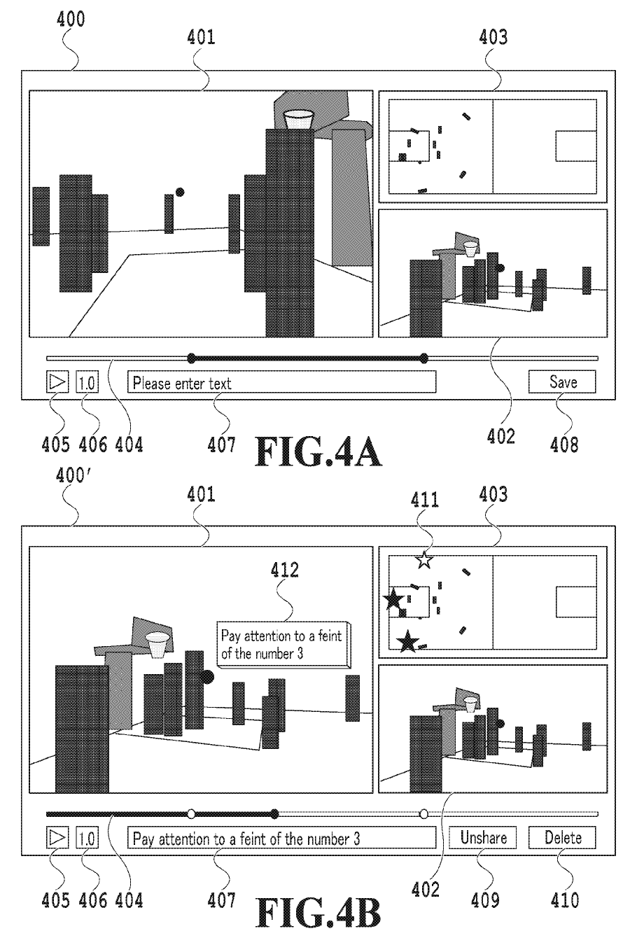

Next, graphical user interfaces (GUIs) of the first user terminal 100A will be described. Here, a situation where the graphical user interfaces (GUIs) of the first user terminal 100A are used by a coach of basketball as the first user for giving an instruction to a player as the second user will be described as an example. FIG. 4A shows a GUI when the aforementioned sharing information has not been generated, and a screen sharing operation is not being received from the coach, and FIG. 4B shows a GUI when the aforementioned sharing information has already been generated, and a screen sharing operation is being received from the coach. Hereinafter, each GUI will be described.

### GUI While Screen Sharing Operation Is Not Being Received

A GUI 400 shown in FIG. 4A is configured with UI elements of three image areas 401 to 403, a seek bar 404, a play/pause button 405, a speed button 406, a text entry field 407, and a save button 408.

The image area 401 is an image area in which a second virtual viewpoint image which is displayed in the second user terminal 100B is displayed. This allows the coach to check a virtual viewpoint image which the player is viewing. Now, a virtual viewpoint image at a certain instant during a game of basketball is displayed in the image area 401, and a vertically long cuboid is a figure schematically representing a human, and a sphere is a figure representing a basketball.

The image area 402 is an image area for the first user to prepare a second virtual viewpoint image, and is an image area in which a first virtual viewpoint image which only the first user can view is displayed. For example, the coach can designate a desired position and orientation by operating a virtual camera using the input device 107 of the first user terminal 100A. For example, in the case where the input device 107 is a mouse, the coach changes the position of the virtual camera by a drag operation of the left click, for example, and changes the orientation of the virtual camera by a drag operation of the right click, for example, on the image area 402.

The seek bar 404 is a UI element indicating a play section of a virtual viewpoint image. For example, the coach can set any desired play section by operating a left circle mark corresponding to the starting point and a right circle mark corresponding to the ending point on the seek bar 404 to designate starting/ending time codes of a second virtual viewpoint image which the coach wants to show the player.

The play/pause button 405 is a button for controlling play or pause of a first virtual viewpoint image displayed in the image area 402. The speed button 406 is a button for changing the play speed of a first virtual viewpoint image displayed in the image area 402, and a desired play speed can be designated from options presented by pull-down, for example. For example, in the case where the play speed is "1.0", a first virtual viewpoint image is played at a normal speed, in the case where the play speed is less than "1.0", a first virtual viewpoint image is played at a slow speed, and in the case where the play speed is more than "1.0", a first virtual viewpoint image is played at a high speed.

The text entry field 407 is a UI element for inputting a character string as the content of an instruction from the first user to the second user. For example, the coach fills in a reminder, a briefing, or the like to the player with a simple text by using a keyboard as the input device 107. A text box which is a mode of the instruction model is generated based on a character string inputted here.

The image area 403 is an image area for displaying a virtual viewpoint image (hereinafter, referred to as an "overview image") corresponding to such a fixed virtual viewpoint to get an overview of an image capturing region (a basketball court in the present embodiment) by the plurality of sensor systems 10. Like the image area 402, an overview image (that is, a bird's-eye view image) displayed in the image area 403 can be viewed by only the coach, who is the first user. Now, in the image area 403, a virtual viewpoint image of the entire basketball court as viewed from above is displayed, and black rectangles in the image are figures representing players during the game. From the overview image displayed in the image area 403, the coach can easily grasp the positional relations of the players during the game.

The save (Save) button 408 is a button for, after the first user designates the position·orientation of the virtual camera for a second virtual viewpoint image, and the content of an instruction to the second user, saving these pieces of information as sharing information. Note that while the screen sharing operation is not being received (when sharing information is not selected), by repeatedly conducting the operation of setting the above-mentioned sharing information and pressing down the save button 408, a plurality of pieces of sharing information can be saved. Once sharing information is saved, the same number of marks as the number of pieces of sharing information saved are displayed on the overview image of the image area 403 as shown in FIG. 4B, which will be described later.

### GUI While Screen Sharing Operation Is Being Received

A GUI 400' shown in FIG. 4B is configured with UI elements of three image areas 401 to 403, a seek bar 404, a play/pause button 405, a speed button 406, a text entry field 407, an unshare button 409, and a delete button 410. The image areas 401 to 403, the seek bar 404, the play/pause button 405, the speed button 406, and the text entry field 407 are common with the GUI 400 of FIG. 4A. Hereinafter, differences from the GUI 400 of FIG. 4A will be described.

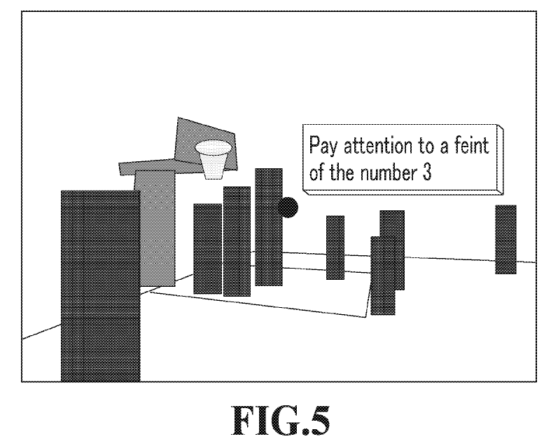

Now, in an overview image displayed in the image area 403 of the GUI 400', there are three star-shaped marks 411 each indicating sharing information. Then, the arrangement of the three marks 411 represents display positions of instruction models contained respectively in pieces of sharing information which have been saved, in a virtual space. The coach disposes a mark 411 by, for example, left-clicking or the like at a desired position in the overview image. In this way, the position (two-dimensional coordinate values in an xy plane horizontal to the court) on the court to display an instruction model is determined. Here, it is assumed that the coordinate value in a direction (the z-axis direction) perpendicular to the court is a predetermined value such as a height of 2 m, for example. Note that the operation method described here is an example, and for example, the left click may be assigned to another function (for example, the movement of a virtual camera in the image area 402). In this case, the display position of an instruction model may be determined by another operation method such as left-clicking while pressing down the Ctrl key, for example. By such an operation, the position (three-dimensional coordinate values) in the virtual space to display an instruction model is determined. After the mark 411 is disposed in the overview image and the display position of the instruction model is determined in this way, once the coach presses down the aforementioned save button 408, the mark 411 continues being displayed in the overview image of the image area 403. Then, in the case where the coach conducts a screen sharing operation (for example, a mark selecting operation such as pointing the cursor at a desired mark 411 and right-clicking), a second virtual viewpoint image is generated based on the sharing information according to the screen sharing operation, and is displayed on the first user terminal 100A and the second user terminal 100B. FIG. 5 shows a second virtual viewpoint image displayed on the HMD as the second user terminal 100B. In this way, a virtual viewpoint image containing a text box 412 of a character string "Pay attention to a feint of the number 3" which the coach inputted into the text entry field 407 is displayed on both of the image area 401 of the GUI 400' and the HMD. This means that the screen sharing operation of the coach forcibly switches the screen display in the HMD to the virtual viewpoint image with an instruction of the coach from a viewpoint at which the coach wants to show. In this way, the coach can surely show the player the virtual viewpoint image which contains the content of the instruction the coach wants to convey to the player and which the coach wants to show the player.

The unshare button 409 is a button for the first user to unshare a screen sharing operation. While a screen sharing operation from the first user is being received, this unshare button 409 is displayed. Once the unshare button 409 is pressed down, sharing information according to the screen sharing operation which is currently being received is changed from a selected state to a non-selected state, and the generation·output of a second virtual viewpoint image based on the sharing information is stopped.

The delete button 410 is a button for deleting desired a piece of sharing information among the saved pieces of sharing information. For example, once this delete button 410 is pressed down while a screen sharing operation is being received (while sharing information has been selected), all the content of the selected sharing information is deleted. This makes it possible for the coach to delete sharing information which has not been necessary anymore.

### Processing of Image Processing Apparatus 200

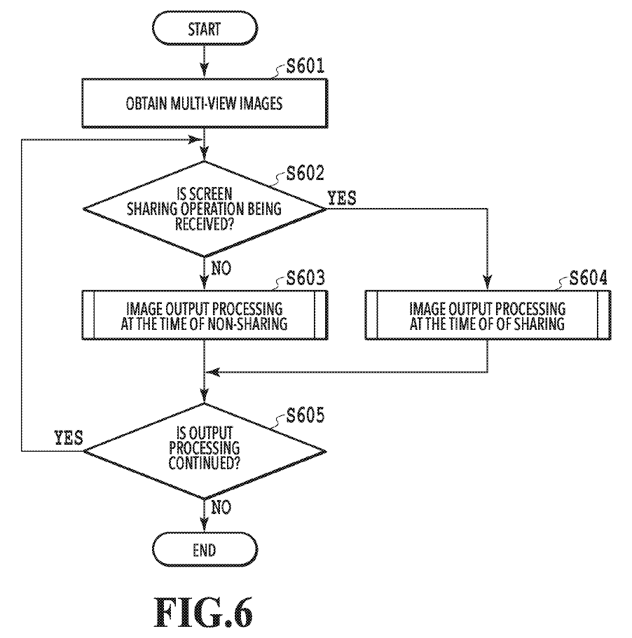

Subsequently, generation·output processing of a virtual viewpoint image which is conducted by the image processing apparatus 200 will be described using flowcharts of FIG. 6 to FIG. 8. A series of processing shown in the flowcharts of FIG. 6 to FIG. 8 are implemented by the CPU 201 or the GPU 206 deploying software stored in the ROM 203 onto the RAM 202, and executing the software.

### Main Flow

FIG. 6 is a flowchart showing a rough flow of image generation processing in the image processing apparatus 200 according to the present embodiment, and is executed for each frame. Hereinafter, the description will be made with reference to the flowchart of FIG. 6. Note that in the following description, sign "S" means a step.

At S601, multi-view images as material data necessary for generating a virtual viewpoint image are obtained from a database (not shown).

At S602, processing to be executed next is switched depending on whether a screen sharing operation by the first user (an operation of selecting a mark displayed on an overview image in the present embodiment) is being received. If a screen sharing operation is not being received, S603 is executed next. If a screen sharing operation is being received, S604 is executed next.

At S603, an image output processing in the case where a screen sharing operation by the first user is not being received is executed. On the other hand, at S604, an image output processing in the case where a screen sharing operation by the first user is being received is executed. The detail of the image output processing in each of S603 and S604 will be described later.

At S605, it is determined whether or not the output processing of the virtual viewpoint image is continued, and if the output processing is continued, the processing returns to S602, and the processing is continued on the next frame. On the other hand, if the output processing is not continued (for example, if the application for playing a virtual viewpoint image has been ended), the processing of the present flowchart is ended. The rough flow of the image output processing in the image processing apparatus 200 is as described above.

### Image Output Processing While Screen Sharing Operation Is Not Being Received

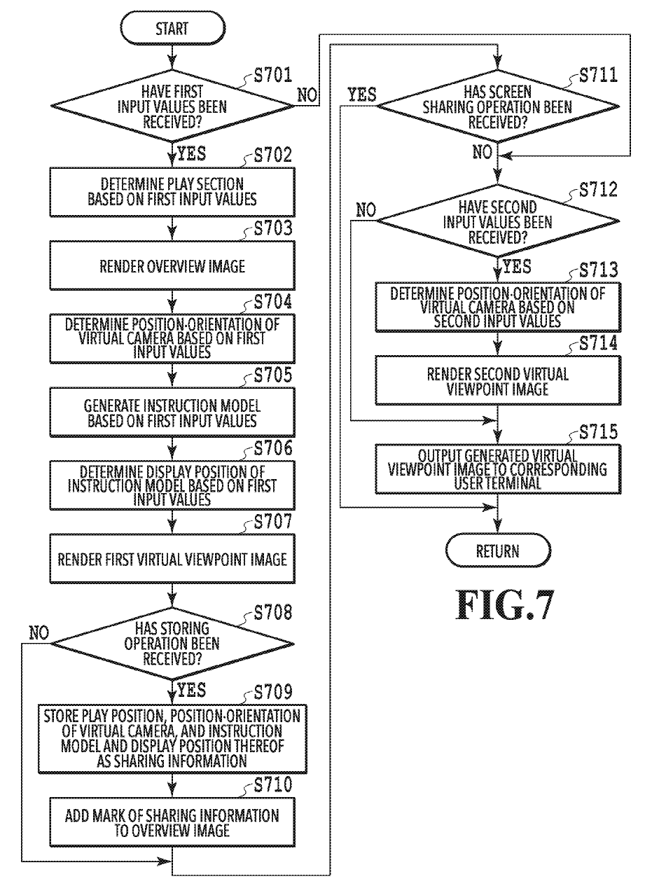

FIG. 7 is a flowchart showing a detail of image output processing in the case where a screen sharing operation by the first user is not being received, in the above-mentioned S603. Hereinafter, the description will be made with reference to the flowchart of FIG. 7. Note that in the following description, sign "S" means a step.

At S701, processing to be executed next is switched depending on whether control values (hereinafter, referred to as "first input values") according to an operation input by the first user have been inputted from the first user terminal 100A. If first input values have not been received, S712 is executed next, and if first input values have been received, S702 is executed next.

At S702, the first play section determination unit 301 determines a play section of a first virtual viewpoint image based on the first input values received at S701. The first input values assumed here are control values such as time codes, in accordance with the operation input of the mouse or the like by the first user to the seek bar 404 in the GUI 400 shown in the aforementioned FIG. 4, for example. For example, the first user designates a starting time code and an ending time code by dragging both ends of the seek bar 404, or the like. Note that in the case where the first input values received at S701 are not input values on a play section, the present step is skipped.

At S703, the first video generation unit 303 causes the GPU 206 to execute rendering processing of a target frame among the multi-view images obtained at S601, based on the play section determined at S702. In this way, a virtual viewpoint image (an overview image) representing an appearance from an overview point set in advance is generated. Note that the generation of an overview image may be conducted by the second video generation unit 309, or a third video generation unit (not shown) for generating an overview image may be separately provided.

At S704, the first viewpoint determination unit 302 determines the position and orientation of the virtual camera based on the first input values received at S701. The first input values assumed here are control values in accordance with an input operation to designate the position and orientation of the virtual camera by the first user using the mouse or the like to the image area 402 in the GUI 400 shown in the aforementioned FIG. 4A, for example. Note that in the case where the first input values received at S701 are not input values on the position·orientation of the virtual camera, the present step is skipped.

At S705, the sharing information generation unit 304 generates an instruction model based on the first input values received at S701. The first input values assumed here are a character string inputted into the text entry field 407 in the GUI 400 shown in the aforementioned FIG. 4A, for example, and a text block containing this character string is generated by CG (computer graphics). The text block thus generated is held in the RAM 202. Note that in the case where the first input values received at S701 are not input values on the generation of an instruction model, the present step is skipped.

At S706, the sharing information generation unit 304 determines a display position of the instruction model generated at S705 in the virtual space (the position on the x-y plane), based on the first input values received at S701. The first input values assumed here are input operation signals designating the position of the virtual camera by the first user using the mouse or the like to the image area 403 in the GUI 400 shown in the aforementioned FIG. 4A, for example. Note that in the case where the first input values received at S701 are not input values on the display position of the instruction model, the present step is skipped.

At S707, the first video generation unit 303 causes the GPU 206 to execute rendering processing of a target frame among the multi-view images obtained at S601, based on the play section determined at S702. In this way, a first virtual viewpoint image representing an appearance from the virtual camera determined at S704 is generated.

At S708, processing to be executed next is switched depending on whether or not the first input values received at S701 are an operation of storing sharing information. If the received first input values are an operation of storing sharing information (for example, if the first input values are signal values indicating the pressing down of the save button 408 in the GUI 400 shown in the aforementioned FIG. 4A), S709 is executed next. On the other hand, if the received first input values are not an operation of storing sharing information, S711 is executed next.

At S709, the sharing information generation unit 304 associates and stores the play section determined at S702, the position·orientation of the virtual camera determined at S704, and the instruction model and the display position thereof generated/determined at S705/S706 as sharing information. When the sharing information is stored, an ID or the like is added for distinction from other sharing information, and is stored in the HDD 207, for example.

At S710, a mark (a star-shaped mark in the present embodiment) representing the sharing information stored at S709 is added to the overview image generated at S703 based on the position in the virtual space (the position on the x-y plane) determined at S706.

At S711, processing to be executed next is switched depending on whether the first input values received at S701 are control values for a screen sharing operation (an operation of selecting a mark displayed on the overview image in the present embodiment) by the first user. If the received first input values are a screen sharing operation, the present processing is finished, and the processing returns to the flowchart of FIG. 6. If the received first input values are not a screen sharing operation, S712 is executed next.

At S712, processing to be executed next is switched depending on whether values according to an operation input by the second user (hereinafter, referred to as "second input values") have been inputted from the second user terminal 100B. If second input values have not been received, S715 is executed next, and if second input values have been received, S713 is executed next.

At S713, the second viewpoint determination unit 308 determines the position and orientation of the virtual camera based on the second input values received at S712. The second input values assumed here are sensor signal values in accordance with the movement of the head of the second user who is wearing an HMD as the second user terminal 100B, for example. Note that if the second input values received at S712 are not input values on the position·orientation of the virtual camera, the present step and next S714 are skipped.

At S714, the second video generation unit 309 causes rendering processing of a target frame among the multi-view images obtained at S601 to be executed based on the play section determined at S702. In this way, a virtual viewpoint image (hereinafter, referred to as a "second virtual viewpoint image") representing an appearance from the virtual camera determined at S712 is generated.

At S715, the overview image generated at S703 and the first virtual viewpoint image generated at S707 are transmitted to the first user terminal 100A via the communication unit 204. In addition, the second virtual viewpoint image generated at S714 is transmitted to the first user terminal 100A and the second user terminal 100B via the communication unit 204. Then, in the first user terminal 100A, the received overview image, first virtual viewpoint image, and second virtual viewpoint image are displayed respectively in predetermined image areas on the GUI. In addition, in the second user terminal 100B, the received second virtual viewpoint image is displayed. After the present step is executed, the present flow is finished, and the processing returns to the flowchart of FIG. 6.

The flowchart in the case where a screen sharing operation is not being received has been described above. By such processing, while a screen sharing operation by the first user is not being received, a virtual viewpoint image is generated·outputted in accordance with a play section designated by the first user, and the virtual viewpoint image is played in loop in each of the first user terminal 100A and the second user terminal 100B. In this way, once a virtual viewpoint image is generated, it subsequently becomes possible for the user to repeatedly view the virtual viewpoint image of the same scene without operation.

### Image Output Processing While Screen Sharing Operation Is Being Received

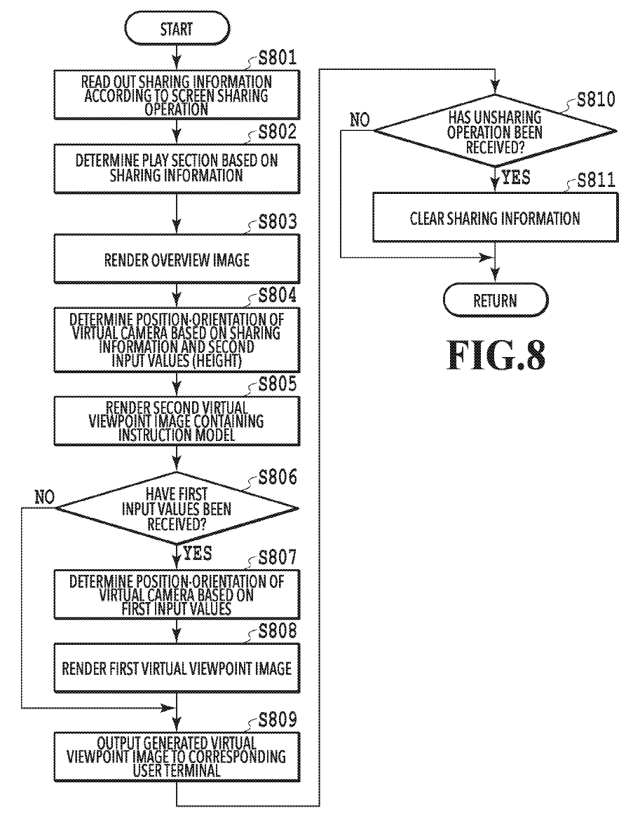

FIG. 8 is a flowchart showing a detail of image output processing in the case where a screen sharing operation by the first user is being received, in the above-mentioned S604. Hereinafter, the description will be made with reference to the flowchart of FIG. 8. Note that in the following description, sign "S" means a step.

At S801, the sharing processing unit 306 reads out sharing information according to a screen sharing operation which is being received (sharing information associated with a selected mark in the present embodiment) from the HDD 207, and holds the sharing information in the RAM 202. Note that if sharing information according to the screen sharing operation which is being received has been read out, the present step is skipped from then.

At S802, the second play section determination unit 307 determines a play section of a second virtual viewpoint image based on the sharing information read out at S801. Specifically, a starting time code and an ending time code contained in the sharing information thus read out are set as a play section. Based on the play section set in this manner, play is started from a position of the starting time code of the seek bar 404, and the play is continued until a position of the ending time code. Note that if sharing information according to the screen sharing operation which is being received has been read out, the present step is skipped from then.

At S803, the second video generation unit 303 causes the GPU 206 to execute rendering processing based on the multi-view images obtained at S601 to generate an overview image representing an appearance from an overview point set in advance. Note that the generation of an overview image may be conducted by the first video generation unit 303, or a third video generation unit (not shown) for generating an overview image may be separately provided.

At S804, the second viewpoint determination unit 302 determines the position and orientation of the virtual camera based on the sharing information read out at S801 and a second input value inputted from the second user terminal 100B. As mentioned above, the position (x, y) and the orientation (pan, tilt, roll) of the virtual camera are determined to be values of the position·orientation contained in the sharing information, and the height (x) of the virtual camera is determined in accordance with an operation signal value of the second user.

At S805, the second video generation unit 309 causes the GPU 206 to execute rendering processing based on the multi-view images obtained at S601 to generate a second virtual viewpoint image representing an appearance from the virtual camera determined at S804. Specifically, an instruction model (a text box in the present embodiment) contained in the sharing information read out at S801 is disposed in a virtual space based on a display position contained in the sharing information, and is rendered together with a 3D model of a player. In this event, the text box is disposed to face in front of the virtual camera so that the viewer can easily recognize text information in the text box. In this way, a virtual viewpoint image containing an instruction model expressing the content of the instruction of the coach is generated. Note that since the content of the instruction has to be only reflected in the virtual viewpoint image, for example, a configuration in which rendering processing is conducted without an instruction model being disposed in a virtual space, and a two-dimensional CG corresponding to the instruction model is synthesized to an obtained virtual viewpoint image may be employed.

At S806, processing to be executed next is switched depending on whether control values (first input values) according to an operation input by the first user have been inputted from the first user terminal 100A. If first input values have not been received, S809 is executed next, and if first input values have been received, S807 is executed.

At S807, the first viewpoint determination unit 302 determines the position and orientation of the virtual camera based on the first input values received at S806. At the subsequent S808, the first video generation unit 303 causes the GPU 206 to execute rendering processing based on the multi-view images obtained at S601 to generate a first virtual viewpoint image representing an appearance from the virtual camera determined at S807. In this event, like the above-mentioned S805, a virtual viewpoint image containing an instruction model may be generated. In this case, the coach can check how the instruction model is displayed on the first virtual viewpoint image, before showing the instruction model to the second user.

At S809, the overview image generated at S803 and the first virtual viewpoint image generated at S808 are transmitted to the first user terminal 100A via the communication unit 204. In addition, the second virtual viewpoint image containing the instruction model generated at S805 is transmitted to the first user terminal 100A and the second user terminal 100B via the communication unit 204. Then, in the first user terminal 100A, the received overview image, first virtual viewpoint image, and second virtual viewpoint image containing the instruction model are displayed respectively in predetermined image areas on the GUI. In addition, in the second user terminal 100B, the received second virtual viewpoint image containing the instruction model is displayed.

At S810, processing to be executed next is switched depending on whether an operation of unsharing the screen sharing by the first user (an operation of pressing down the delete button 410 in the present embodiment) has been inputted from the first user terminal 100A. If an operation of unsharing the screen sharing from the first user terminal 100A has not been received, the present processing is finished, and the processing returns to the flowchart of FIG. 6. On the other hand, if an operation of unsharing the screen sharing has been received, S811 is executed. Then, at S811, the sharing processing unit 306 clears the sharing information held in the RAM 202. After the clearing, the processing returns to the flowchart of FIG. 6.

The flowchart in the case where a screen sharing operation is being received has been described above. By such processing, while a screen sharing operation by the first user is being received, a virtual viewpoint image is generated·outputted in accordance with a play section contained in sharing information, and the virtual viewpoint image is played in loop in each of the first user terminal 100A and the second user terminal 100B. In this way, once a virtual viewpoint image is generated, it becomes possible for the user to repeatedly view the virtual viewpoint image of the same scene without operation from then.

By the series of these processings, for example, it becomes possible for the coach to forcibly make the player view a virtual viewpoint image with an instruction to the player from a viewpoint at which the coach wants to show. Note that in both of the first virtual viewpoint image and the second virtual viewpoint image, processing such as play, pause, and change in play speed is executed as needed by interruption processing during the processing of the flowcharts of the above-mentioned FIG. 6 to FIG. 8.

### Modifications

While a screen sharing operation is being received, the second viewpoint determination unit 308 may determine the position·orientation of a virtual camera based on a display position of an instruction model contained in sharing information. For example, by determining the position·orientation of the virtual camera such that an instruction model to be disposed at a designated position in a virtual space comes to a predetermined position ( for example, the center of the screen, the right corner of the screen, or the like) in a virtual viewpoint image, it is possible to easily output the virtual viewpoint image in which the content of the instruction is displayed at a position where the second user can readily recognize the content of the instruction.

In the above-mentioned embodiment, one image processing apparatus 200 generates·outputs both of a first virtual viewpoint image and a second virtual viewpoint image. However, for example, two image processing apparatuses 200 may be prepared such that each of the image processing apparatuses 200 generates·outputs a first virtual viewpoint image and a second virtual viewpoint image. In this case, the two image processing apparatuses 200 communicate with each other to share their information, and output synchronization control for virtual viewpoint images for which each is responsible is conducted. In addition, for example, the first user terminal 100A may have the function of the image processing apparatus 200 as well.

In the case where a mark 411 on an overview image is selected by the first user, the forcible switching to a virtual viewpoint image based on sharing information according to the selection does not have to be executed immediately. For example, after the first user selects a mark 411, a message preliminarily announcing the switching of the viewpoint may be displayed in an overlaid manner for a few seconds in a second virtual viewpoint image which the second user is viewing, and then forcible switching may be conducted. This can reduce confusion which would occur in the case where the viewpoint suddenly changes during the viewing of a virtual viewpoint image. In addition, the forcible switching of a virtual viewpoint image by a screen sharing operation by a first user may be controlled such that the forcible switching is limited to only when a selecting operation for a mark 411 is continuously conducted, for example, and a viewpoint operation by the second user is made possible after the first user stops the selecting operation. In this case, the second user wearing the HMD can reduce VR sickness which would occur from the movement of the viewpoint which the second user does not intend.

Although in the above-mentioned embodiment, the determination of the display position of an instruction model and the reception of a screen sharing operation are conducted based on an input operation using a mouse or the like to an overview image, the configuration is not limited to this. For example, the display position of an instruction model may be determined by the first user directly inputting three-dimensional coordinate values on the GUI. In addition, the reception of a screen sharing operation may be conducted in such a way that a list of stored sharing information is displayed on the GUI by pull-down, and the first user selects the screen sharing operation from options in the list.

Although in the above-mentioned embodiment, the content of an instruction by the first user is contained in a second virtual viewpoint image generated while a screen sharing operation is being received, a range in which the content of an instruction is displayed in the screen can be separately set. In this case, for example, after starting/ending time codes for controlling a play section is set on the seek bar 404, starting/ending time codes for displaying the content of an instruction is set within the range. In this way, for example, while making the player view a virtual viewpoint image in a reproduction range which the coach wants to show for the coaching, the coach can cause the content of the instruction to be displayed in that certain section, for example, to further strongly make the player conscious about the content of the instruction. Moreover, a plurality of display positions of the contents of an instruction may be designated in association with time codes such that the content of the instruction moves from the start to the end of the second virtual viewpoint image. In this way, for example, even in the case where an object (for example, a specific player of the opposing team) to which the coach wants the player to pay attention moves in a play section, the content of the instruction can be caused to follow the object. In addition, by designating a specific player or the like which the coach wants the content of the instruction to follow, for example, by using an object recognition/following technology, the content of the instruction may be caused to move to follow the specific player.

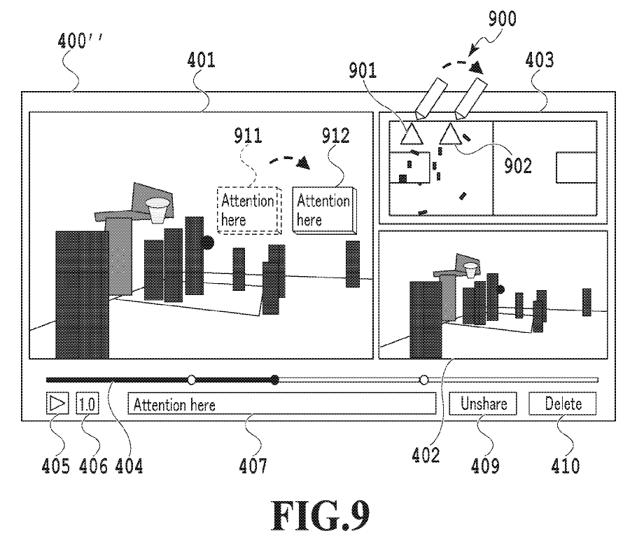

In addition, a change of sharing information may be received while a screen sharing operation is being received such that a second virtual viewpoint image reflecting the content after the change can be generated·outputted. FIG. 9 is an example of a GUI 400'' in the present modification. A touch pen 900 is added to the GUI 400' of the aforementioned FIG. 4B. Then, a new character string "Attention here" is inputted into the text entry field 407, and a corresponding instruction model (a text block 911) is displayed on the first virtual viewpoint image of the image area 401. Here, it is assumed that the first user selected a mark 901 on the overview image by using the touch pen 900, and has dragged and moved the mark to the position of a mark 902. Then, the text block 911 moves to the text block 912 in conjunction with the movement of the mark. Such change and movement of an instruction model is conducted at S805 of the flow of the aforementioned FIG. 8. Specifically, the change and movement of an instruction model is conducted by generating a text block 912 of a newly inputted character string, and disposing and rendering the text block 912 at a two-dimensional coordinate position on the xy plane, which is shown by the mark after the movement operation. Note that the operation of moving a mark may be conducted with a mouse or the like instead of a touch pen. In addition, the position·orientation of the virtual camera may be changed in conjunction with the movement of an instruction model. For example, such a configuration that the orientation of the virtual camera is changed while the position of the virtual camera is fixed in conformity to an instruction model moving in such a manner as to be maintained at a center of a second virtual viewpoint image may be employed. In this way, by moving an instruction model in accordance with the movement of an object in a virtual viewpoint image, the first user can attract the attention of the second user to a portion at which the first user wants attention.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, a plurality of users can smoothly communicate with each other while sharing a virtual viewpoint image.

This application claims the benefit of Japanese Patent Application No. 2024-196608, filed November 11, 2024 which is hereby incorporated by reference herein in its entirety.

What is claimed is:

1. An image processing apparatus comprising:
one or more memories storing instructions; and
one or more processors executing the instructions to:
receive an operation of a first user;
generate, based on the received operation of the first user, a virtual viewpoint image based on a plurality of images captured by a plurality of image capturing apparatuses, the virtual viewpoint image reflecting an instruction from the first user to a second user; and
output the generated virtual viewpoint image to a user terminal used by the second user, based on the operation of the first user.

2. The image processing apparatus according to claim 1, wherein the virtual viewpoint image is generated by disposing a 3D model expressing the instruction in a virtual space, and conducting rendering processing in accordance with a virtual viewpoint designated by the first user.

3. The image processing apparatus according to claim 2, wherein
the one or more processors further execute the instructions to:
output the generated virtual viewpoint image to a user terminal used by the first user, wherein
the virtual viewpoint image is displayed on both of the user terminal used by the first user and the user terminal used by the second user.

4. The image processing apparatus according to claim 3, wherein the virtual viewpoint image is generated based on a screen sharing operation from the first user, which has been received as the operation of the first user.

5. The image processing apparatus according to claim 4, wherein
the one or more processors further execute the instructions to:
store information, which is received as the operations of the first user, containing a content of the instruction from the first user to the second user, a position of the 3D model in the virtual space, and a position and orientation of a virtual camera corresponding to the virtual viewpoint, wherein
the screen sharing operation is an operation of selecting the stored information.

6. The image processing apparatus according to claim 5, wherein
the operation of the first user is received via a GUI (graphical user interface), and
a mark corresponding to the stored information is displayed on the GUI.

7. The image processing apparatus according to claim 6, wherein
the GUI includes an overview image corresponding to a viewpoint to get an overview of an area where the plurality of image capturing apparatuses capture images, and
the mark is displayed on the overview image.

8. The image processing apparatus according to claim 7, wherein a position of the mark displayed on the overview image represents the position of the 3D model in the virtual space.

9. The image processing apparatus according to claim 6, wherein the GUI includes an entry field for the first user to input a character string as the content of the instruction from the first user to the second user.

10. The image processing apparatus according to claim 6, wherein
the one or more processors further execute the instructions to:
generate, based on the operation of the first user, another virtual viewpoint image based on a plurality of images captured by the plurality of image capturing apparatuses; and
not output the generated other virtual viewpoint image to the user terminal used by the second user, but output the generated other virtual viewpoint image to the user terminal used by the first user, wherein
the other virtual viewpoint image is displayed on the GUI.

11. The image processing apparatus according to claim 10, wherein the position and orientation of the virtual camera corresponding to the virtual viewpoint is determined based on the operation of the first user using the other virtual viewpoint image on the GUI.

12. The image processing apparatus according to claim 6, wherein the position and orientation of the virtual camera corresponding to the virtual viewpoint is determined based on the position of the 3D model in the virtual space, which is contained in the selected information.

13. The image processing apparatus according to claim 10, wherein
the virtual viewpoint image and the other virtual viewpoint image are moving images,
the stored information further contains play sections of the virtual viewpoint image and the other virtual viewpoint image, which are received as the operations of the first user, and
the GUI includes a UI element for the first user to input the play sections.

14. An image processing method comprising the steps of:
receiving an operation of a first user;
generating, based on the received operation of the first user, a virtual viewpoint image based on a plurality of images captured by a plurality of image capturing apparatuses, the virtual viewpoint image reflecting an instruction from the first user to a second user; and
outputting the generated virtual viewpoint image to a user terminal used by the second user, based on the operation of the first user.

15. A non-transitory computer readable storage medium storing a program for causing a computer to perform an image processing method comprising the steps of:
receiving an operation of a first user;
generating, based on the received operation of the first user, a virtual viewpoint image based on a plurality of images captured by a plurality of image capturing apparatuses, the virtual viewpoint image reflecting an instruction from the first user to a second user; and
outputting the generated virtual viewpoint image to a user terminal used by the second user, based on the operation of the first user.
